(19) United States
(12) Patent Application Publication
(10) Pub. No.: US 2012/0181227 A1
(43) Pub. Date: Jul. 19, 2012

(54) FILTER FOR A COFFEE MAKER

(76) Inventor: George J. Sowden, Milano (IT)

(21) Appl. No.: 13/498,549

(22) PCT Filed: Sep. 17, 2010
(86) PCT No.: PCT/IB2010/002382

§ 371 Date: Mar. 27, 2012

(30) Foreign Application Priority Data
Sep. 28, 2009 (IT) TO2009A000733

(51) Int. Cl. A47J 31/20; B01D 35/02

(52) U.S. Cl. 210/474

(57) ABSTRACT

A filter is for a coffee maker in which coffee is obtained by immersion in hot water of ground coffee. The coffee maker includes a body (2) within which a tank for the liquid to be warmed or already warmed and to be put in contact with the ground coffee is obtained, an upper opening (23) from which the liquid is introduced and through which the filter (3) containing the ground coffee is inserted.

The present invention relates to a filter for a coffee maker that is obtained by immersion in hot water of ground coffee.

Normally machines for the preparation of coffee comprise a water tank, which can be opportunely warmed on a conventional cooker, or on an electric hob and successively poured in a jug containing a filter containing the ground coffee which creates the infusion when it is immersed in hot water. These filters can be small paper bags, or paper membranes, which enable the liquid to get through but do not permit the ground coffee to exit from the bag itself or from the membrane and to mix with the water.

Alternatively, these filters are real rigid containers which are inserted in the tank jug containing hot water from the upper opening of the jug itself and sometimes are directly integrated to the cover. These filters are provided with one or more walls which enable the passage of liquid, but do not permit the coffee ground within them to mix in the liquid itself.

The Applicant has realized a filter for a coffee maker wherein the filter itself is immerses in the tank or jug and is obtained through a rigid metallic container, wherein on at least part of its surface is realized a plurality of microscopic holes, in such a way as to create a membrane which enables the liquid to get through, but does not permit the ground coffee contained in it to exit in the jug.

An aspect of the present invention relates to a filter for a coffee maker having the characteristics of the attached claim 1.

The characteristics and advantages of the filter for a coffee maker according to the present invention will be clearer and evident from the following description, exemplificative and non-limiting, of an embodiment with reference to the attached figures wherein:

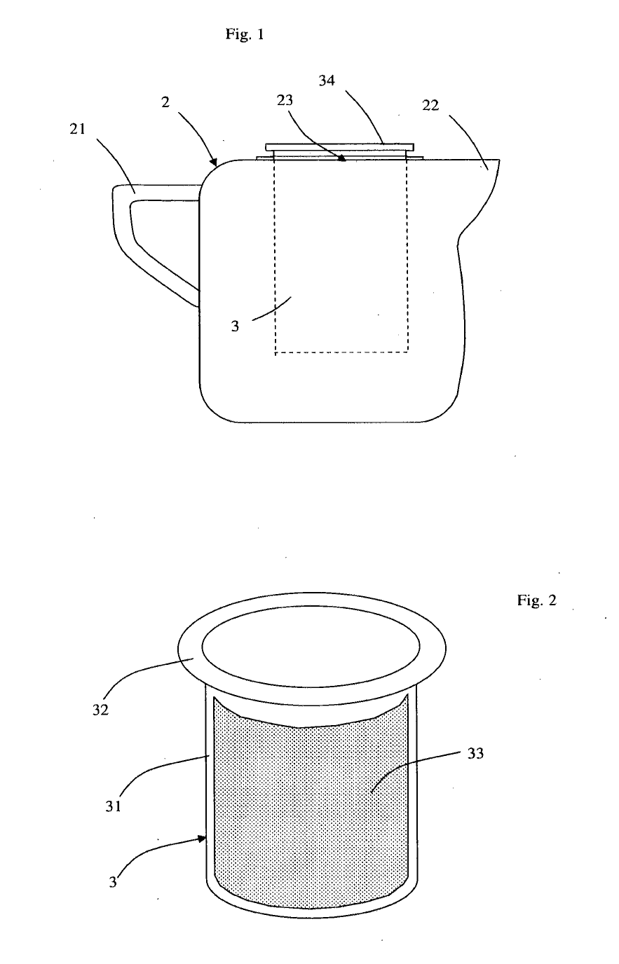

FIG. 1 is a lateral view of the machine for the preparation of coffee according to the present invention;

FIG. 2 is a perspective view of the filter for a coffee maker according to the present invention.

With reference to the mentioned figures, the machine for the preparation of coffee comprises a machine body 2 within which a tank for the water or the liquid to be warmed or already warmed and to be put in contact with the ground coffee is obtained in order to make coffee.

This machine body is conventionally provided with a handle 21 for the gripping and with a nozzle 22, adapted to facilitate the pouring of the coffee prepared. The machine body has an upper opening 23 through which the liquid is introduced and through which a filter 3 is inserted in the body, ground coffee used for making coffee is placed in said filter.

The filter comprises a container 30 of, by way of example, cylindrical, or spherical or semi-spherical shape and an annular portion 32 positioned at the top of the container, adapted to strike against upper opening 23 of the machine body, so that the filter remains completely positioned within the tank and therefore, when it is filled with liquid, it is substantially completely immersed in the liquid itself.

The filter container is made of metal and on at least part of its surface is realized a plurality of microscopic holes 33, in such a way as to create a membrane that enables the liquid to get through, but that does not permit the ground coffee to exit into the jug. The holes can have any shape, but this shape has to be inscribed into a circumference having a diameter not bigger than 0.3 mm, for a plate with a holed areas thickness comprised between 0.1 and 0.3 mm; an ideal diameter is about 0.15 mm.

Preferably, the filter is provided with a cover 34 which closes the jug when it is inserted within the tank through opening 23. Furthermore the container is made of stainless steel, for example SS 304 (stainless steel 304 degree).

The holes are preferably realized on the side surface of the cylindrical body and/or on the bottom of this body.

Holes having so small dimensions can be obtained through a drilling procedure called photo-etching, that is a procedure alternative to cuts and perforations of mechanical type.

The working process is based on the controlled removal of the metal by means of chemical solutions and requires times and equipment costs extremely reduced. The use of photo-etching (chemical machining) on metal is notably advantageous when from thin sheets (from 0.05 mm to 1.5 mm) is necessary to obtain complex profiles, with extremely precise tolerances and in absence of burrs.

1) Filter for a coffee maker, obtained by-immersion in hot water of ground coffee, said coffee machine comprising a machine body within which a tank for liquid to be warmed or already warmed and to be put in contact with the ground coffee is obtained, an upper opening from which the liquid itself is introduced and through which the filter containing the ground coffee is inserted;
the filter comprising: a container made of metal, the container having a surface with a plurality of openings or holes on at least part of the surface to create a membrane that enables the liquid to get through, but that does not permit the ground coffee to exit from the filter, said holes having a shape has to be inscribed into a circumference having a diameter not higher than 0.3 mm, for a plate with a holed areas thickness between 0.1 and 0.3 mm.

2) The filter according to claim 1, wherein the container has a cylindrical shape and an annular portion positioned at the top of the container, against the upper opening of the machine body so that the filter remains completely positioned within the tank.

3) The filter according to claim 1, wherein the diameter of the holes is approximately 0.15 mm.

4) The filter according to claim 1, wherein the container is stainless steel.

5) The filter according to claim 2, wherein the holes are made on a side surface and/or at a bottom of the cylindrical container.

6) The filter according to claim 1, wherein the procedure for obtaining the holes is a photo-etching procedure.

7) The filter according to claim 1, wherein the filter is provided with a cover that closes a jug when the jug is inserted within the tank through the opening.
